(19) United States
(12) Patent Application Publication
(10) Pub. No.: US 2025/0227616 A1
(43) Pub. Date: Jul. 10, 2025

(54) RESOURCE ALLOCATION FOR LP-SS

(71) Applicant: Samsung Electronics Co., Ltd., Suwon-si (KR)

(72) Inventor: Hongbo Si, Allen, TX (US)

(21) Appl. No.: 18/988,863

(22) Filed: Dec. 19, 2024

Related U.S. Application Data
(60) Provisional application No. 63/619,537, filed on Jan. 10, 2024.
(60) Provisional application No. 63/683,008, filed on Aug. 14, 2024.

(51) Int. Cl. H04W 52/02; H04B 7/06; H04L 5/00

(52) U.S. Cl. CPC H04W 52/0235; H04B 7/06968; H04L 5/0007

(57) ABSTRACT

Apparatuses and methods for resource allocation for low power synchronization signal (LP-SS). A method of a user equipment (UE) in a wireless communication system is provided. The method includes receiving a set of higher layer parameters including a system information block (SIB), identifying, based on the SIB, an indication of transmitted synchronization signal and physical broadcast channel (SS/PBCH) blocks in a first burst, and determining, based on the indication, a number of transmissions of a LP-SS in a second burst. The method further includes determining, based on the number of the LP-SS transmissions in the second burst, a set of slots including the LP-SS transmissions in the second burst and receiving the LP-SS based on the set of slots.

### CROSS-REFERENCE TO RELATED AND CLAIM OF PRIORITY

The present application claims priority under 35 U.S.C. § 119(e) to U.S. Provisional Patent Application No. 63/619,537 filed on Jan. 10, 2024 and U.S. Provisional Patent Application No. 63/683,008 filed on Aug. 14, 2024, which are hereby incorporated by reference in their entirety.

### TECHNICAL FIELD

The present disclosure relates generally to wireless communication systems and, more specifically, the present disclosure is related to apparatuses and methods for resource allocation for low power synchronization signal (LP-SS).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to resource allocation for LP-SS.

In one embodiment, a user equipment (UE) in a wireless communication system is provided. The UE includes a transceiver configured to receive a set of higher layer parameters including a system information block (SIB) and a processor operably coupled to the transceiver. The processor is configured to identify, based on the SIB, an indication of transmitted synchronization signal and physical broadcast channel (SS/PBCH) blocks in a first burst; determine, based on the indication, a number of transmissions of a LP-SS in a second burst; and determine, based on the number of the LP-SS transmissions in the second burst, a set of slots including the LP-SS transmissions in the second burst. The transceiver is further configured to receive the LP-SS based on the set of slots.

In another embodiment, a base station (BS) in a wireless communication system is provided. The BS includes a processor configured to determine an indication of transmitted SS/PBCH blocks in a first burst; determine, based on the indication, a number of transmissions of a LP-SS in a second burst; and determine, based on the number of the LP-SS transmissions in the second burst, a set of slots including the LP-SS transmissions in the second burst. The BS further includes a transceiver operably coupled to the processor. The transceiver is configured to transmit a set of higher layer parameters including a SIB. The SIB includes the indication of transmitted SS/PBCH blocks in the first burst and transmit the LP-SS transmissions based on the set of slots.

In yet another embodiment, a method of a UE in a wireless communication system is provided. The method includes receiving a set of higher layer parameters including a SIB, identifying, based on the SIB, an indication of transmitted SS/PBCH blocks in a first burst, and determining, based on the indication, a number of transmissions of a LP-SS in a second burst. The method further includes determining, based on the number of the LP-SS transmissions in the second burst, a set of slots including the LP-SS transmissions in the second burst and receiving the LP-SS based on the set of slots.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates a diagram of an example LP-SS transmission pattern according to embodiments of the present disclosure;

FIG. 6 illustrates a diagram of an example LP-SS transmission pattern according to embodiments of the present disclosure;

FIG. 7 illustrates a diagram of an example LP-SS transmission pattern according to embodiments of the present disclosure;

FIG. 8 illustrates a flowchart of an example UE procedure for resource determination according to embodiments of the present disclosure;

FIG. 9 illustrates a diagram of an example on-off key (OOK) waveform according to embodiments of the present disclosure;

FIG. 10 illustrates a diagram of an example OOK waveform according to embodiments of the present disclosure;

FIG. 11 illustrates a diagram of example binary sequences according to embodiments of the present disclosure;

FIG. 12 illustrates a diagram of example binary sequences according to embodiments of the present disclosure; and

FIG. 13 illustrates a flowchart of an example UE procedure for determining a LP-SS sequence and receiving the LP-SS according to embodiments of the present disclosure.

### DETAILED DESCRIPTION

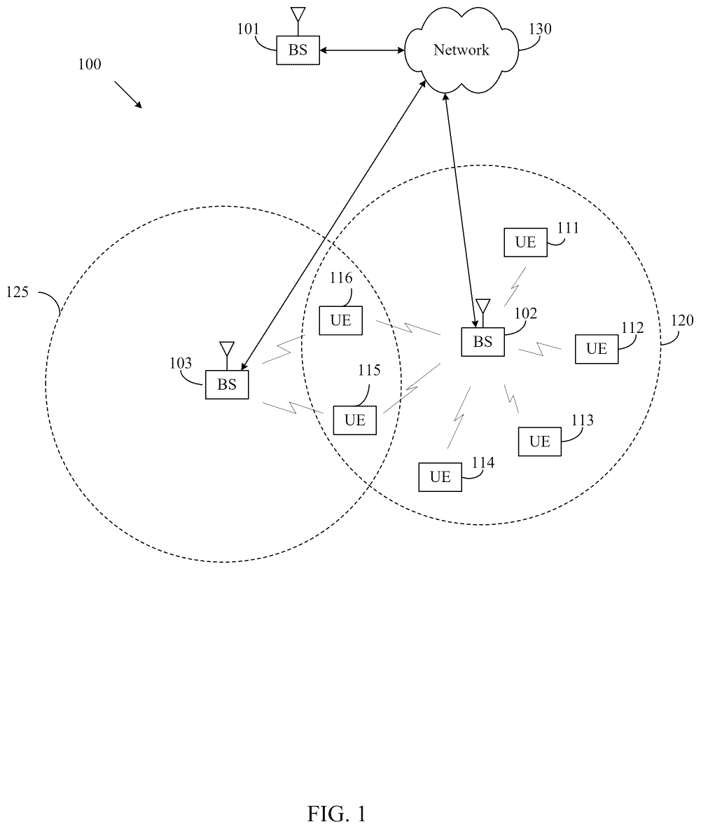

FIGS. 1-13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [1]3GPP TS 38.211 v17.1.0, “NR; Physical channels and modulation;” [2]3GPP TS 38.212 v17.1.0, “NR; Multiplexing and channel coding;” [3] 3GPP TS 38.213 v17.1.0, “NR; Physical layer procedures for control;” [4]3GPP TS 38.214 v17.1.0, “NR; Physical layer procedures for data;” and [5]3GPP TS 38.331 v17.1.0, “NR; Radio Resource Control (RRC) protocol specification.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying a resource allocation for LP-SS. In certain embodiments, one or more of the gNBs 101-103 include circuitry, programing, or a combination thereof to provide for resource allocation for LP-SS.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

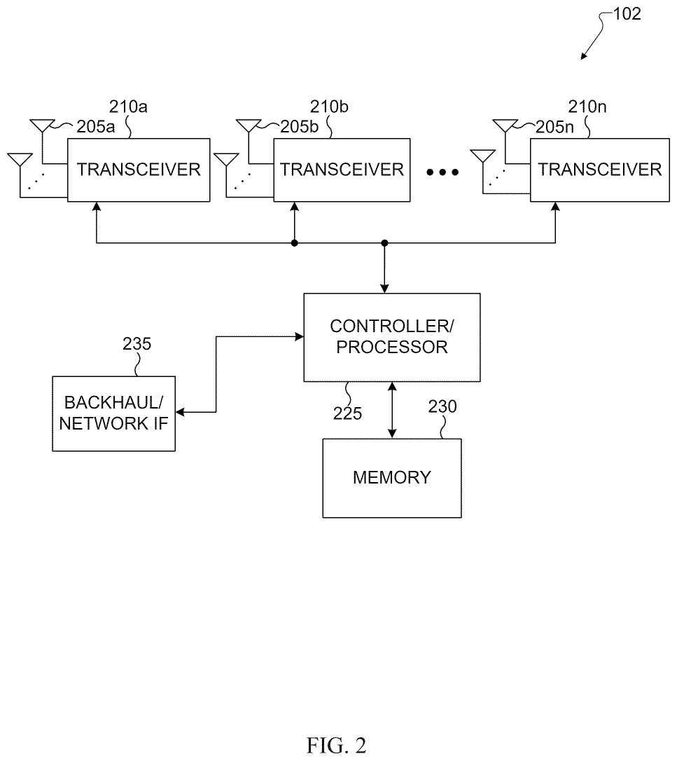

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for resource allocation for LP-SS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

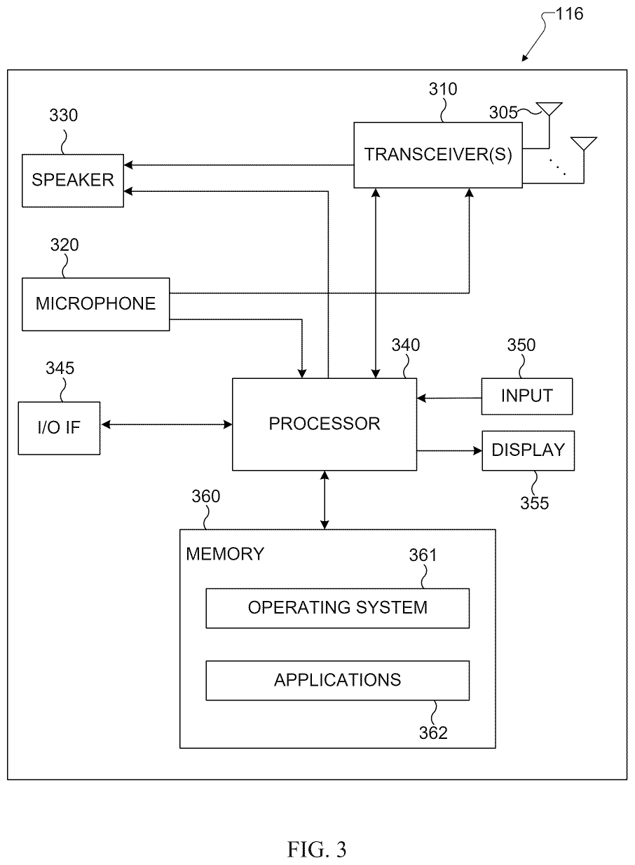

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to utilize and/or identify resource allocation for LP-SS as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

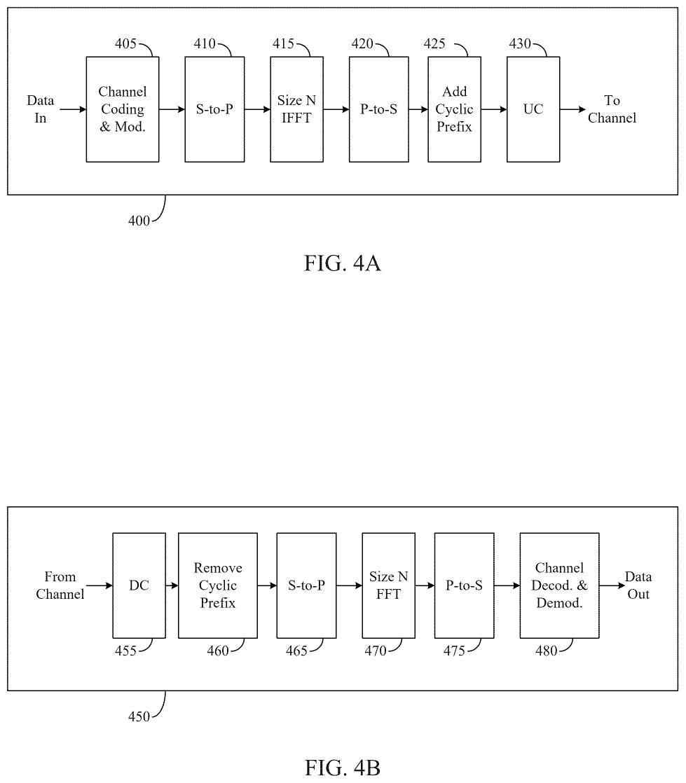

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 perform or utilize resource allocation for LP-SS as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new downlink control information (DCI) format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, embodiments of the present disclosure recognizes that the UE still needs to frequently wake up to monitor the new DCI format or the PEI, such that the radio of the UE cannot be fully turned off for a long duration. To avoid such situation and to acquire further power saving gain, an additional receiver radio is considered, wherein the additional receiver radio can be used for monitoring a particular set of signals with very low power consumption, and the main receiver radio can be turned off or operating with a very lower power for a long duration.

This disclosure provides for resource allocation for a low power synchronization signal (LP-SS) that could be received with low power, e.g., with a waveform enables reception using an additional receiver radio, as well as the resource allocation of other signal or channel based on the transmission of the LP-SS.

This disclosure provides for resource allocation for a low power synchronization signal (LP-SS) that could be received with low power, e.g., with a waveform enables reception using an additional receiver radio, as well as the resource allocation of other signal or channel based on the transmission of the LP-SS. More precisely, the following aspects are included in the disclosure:
Indication of LP-SS transmission
Resource allocation based on the indication of LP-SS transmission
   physical random access channel (PRACH) occasion validation
   physical uplink shared channel (PUSCH) occasion validation
   PUSCH repetition
   HARQ-ACK deferring
   physical downlink control channel (PDCCH) reception
   physical downlink shared channel (PDSCH) reception
   PUSCH transmission
Example UE procedure

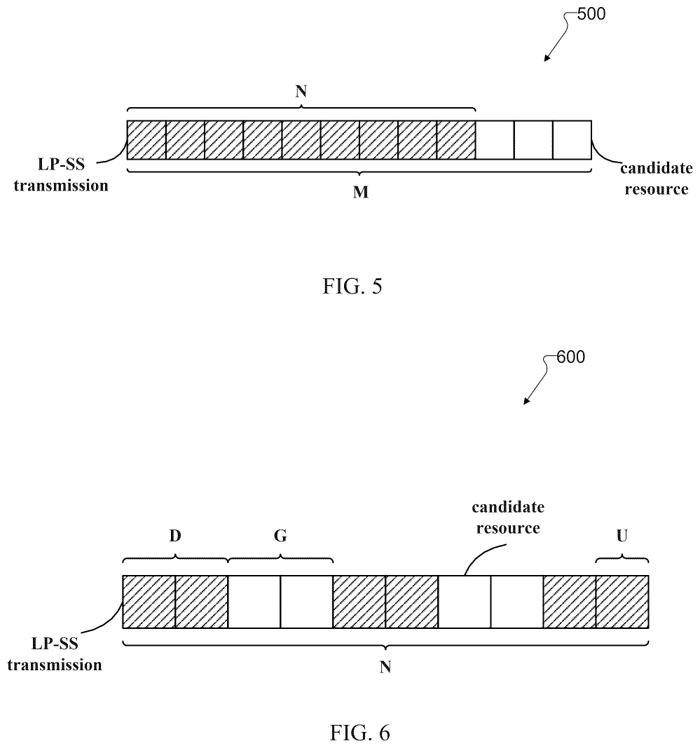

FIG. 5 illustrates a diagram of an example LP-SS transmission pattern 500 according to embodiments of the present disclosure. For example, LP-SS transmission pattern 500 can be utilized by any of the UEs 111-116 of FIG. 1, such as the UE 111. This example is for illustration only and other embodiments can be used without departing from the scope of the present disclosure.

FIG. 6 illustrates a diagram of an example LP-SS transmission pattern 600 according to embodiments of the present disclosure. For example, transmission pattern 600 can be utilized by any of the UEs 111-116 of FIG. 1, such as the UE 112. This example is for illustration only and other embodiments can be used without departing from the scope of the present disclosure.

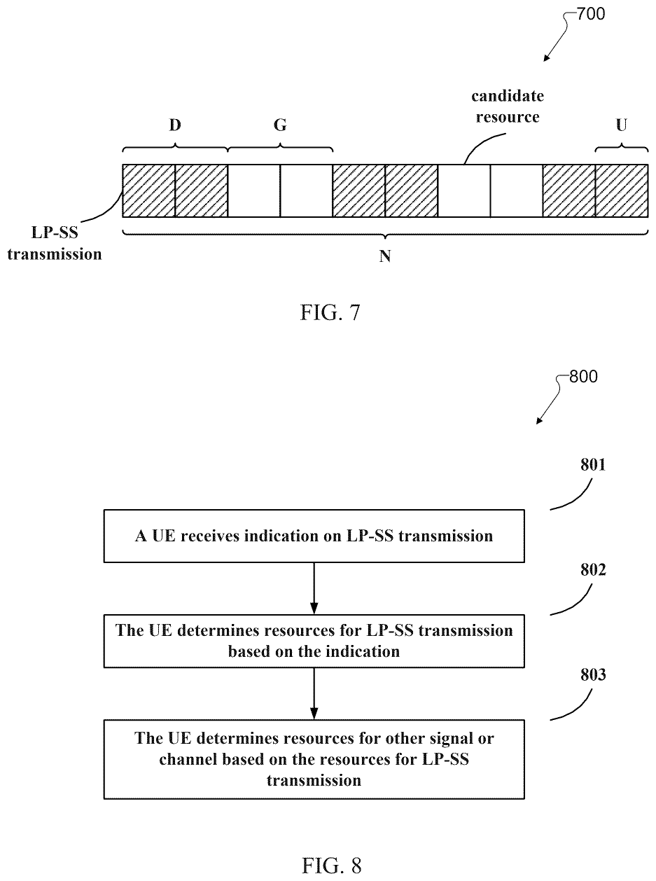

FIG. 7 illustrates a diagram of an example LP-SS transmission pattern 700 according to embodiments of the present disclosure. For example, transmission pattern 700 can be utilized by any of the UEs 111-116 of FIG. 1, such as the UE 113. This example is for illustration only and other embodiments can be used without departing from the scope of the present disclosure.

In one embodiment, an indication of transmission(s) of a low power signal (e.g., for synchronization and/or measurement purpose with a low power receiver, which can be denoted as LP-SS) can be supported.

For one example, the indication can be based on a number of transmissions of LP-SS in a burst (e.g., the bursts can periodically occur in the time domain with a periodicity).
For one sub-example, the number of transmissions in a burst can be identical to or no larger than the maximum number of synchronization signal/physical broadcast channel (SS/PBCH) blocks within a burst (e.g., optionally further depending on a subcarrier spacing and/or a frequency range of the SS/PBCH blocks).
For another sub-example, the number of transmissions in a burst can be identical to or no larger than the number of actually transmitted SS/PBCH blocks within a burst, e.g., determined based on an indication of actually transmitted SS/PBCH blocks in a burst (e.g., by a bitmap provided by ssb-PositionsInBurst).
For yet another sub-example, the number of transmissions in a burst can be identical to or no larger than a predefined value as the maximum number of transmissions. For instance, the maximum number can be further depending on a subcarrier spacing and/or a frequency range.

In one aspect of this example, a UE (e.g., the UE 116) can determine time domain resources for the LP-SS based on the number of transmissions in a burst.

For one sub-example, there can be M predefined or preconfigured candidate time domain resources for the LP-SS transmission, and the UE can determine the first N candidate time domain resources are actually used for LP-SS transmission, wherein N≤M or N=M. With reference to FIG. 5, an illustration of this sub-example is shown. For one instance, N can be configured by a higher layer parameter.

For another sub-example, the starting symbol or slot for the n-th (e.g., 0≤n≤N−1) LP-SS transmission within a burst can be determined as O+U*[(D+G)*[n/D]+(n mod D)]. With reference to FIG. 6, an illustration of this sub-example is shown.
For one instance, U is the number of symbol or slot in one transmission instance for the LP-SS. For one sub-instance, U can be fixed as 1 (slot). For another sub-instance, U can be fixed as 2 (slot). For yet another sub-instance, U can be fixed as 8 (symbols). For yet another sub-instance, U can be configured by a higher layer parameter. For yet another sub-instance, U can be determined based on a number of OOK symbols in a OFDM symbol.
For another instance, O is the offset for the start of the first transmission instance. For one sub-instance, O can be determined based on the configuration of LP-SS. For another sub-instance, O can be fixed as 0. For yet another sub-instance, O can be provided by a higher layer parameter.
For yet another instance, D is the number of consecutive transmission instances in the burst. For one sub-instance, D can be fixed, such as D=1. For another sub-instance, D can be scaled based on the subcarrier spacing for generating the LP-SS. For yet another sub-instance, D can be configured by a higher layer parameter.
For yet another instance, G is the length of gap in the burst. For one sub-instance, G can be fixed (e.g., in one particular sub-instance, G=0, then D=N, and the starting symbol or slot for the n-th (e.g., 0≤n≤N−1) LP-SS transmission within a burst can be determined as O+U*n). For another sub-instance, G can be scaled based on the subcarrier spacing for generating the LP-SS. For yet another sub-instance, G can be configured by a higher layer parameter.

For another example, the indication can be based on a bitmap indicating transmissions of LP-SS in a burst (e.g., the bursts can periodically occur in the time domain with a periodicity).
In one sub-example, the bitmap can be with a number of bits same as the maximum number of SS/PBCH blocks within a burst (e.g., optionally further depending on a subcarrier spacing and/or a frequency range of the SS/PBCH blocks). For this sub-example, the bitmap also provides a one-to-one mapping between LP-SS transmission and the candidate SS/PBCH block occasion, and/or may further expect a same quasi co-location (QCL) assumption between the LP-SS transmission and the associated SS/PBCH block.
For another sub-example, the bitmap can be with a number of bits same as the actually transmitted SS/PBCH blocks within a burst, e.g., determined based on an indication of SS/PBCH blocks in a burst (e.g., by a bitmap provided by ssb-PositionsInBurst). For this sub-example, the bitmap also provides a one-to-one mapping between LP-SS transmission and the actually transmitted SS/PBCH block, and/or may further expect a same QCL assumption between the LP-SS transmission and the associated SS/PBCH block.
For yet another sub-example, the bitmap can be with a number of bits no larger than a predefined value as the maximum number of transmissions. For instance, the maximum number can be further depending on a subcarrier spacing and/or a frequency range.

In one aspect of this example, a UE can determine time domain resources for the LP-SS based on the bitmap. For instance, each bit in the bitmap corresponds to a LP-SS transmission occasion or candidate transmission occasion, and/or the bit taking a first value (e.g., value as 1) indicates the corresponding LP-SS is transmitted, and/or the bit taking a second value (e.g., value as 0) indicates the corresponding LP-SS is not transmitted. With reference to FIG. 7, an illustration of this sub-example is shown.

In one example, the indication can be provided by a higher layer parameter.
For one instance, the indication can be provided by system information block 1 (SIB1).
For another instance, the indication can be provided by system information block x (SIBx), wherein x>1.
For yet another instance, the indication can be provided by dedicated RRC parameters.
For yet another instance, the indication can be provided by UE assistance information.

In one example, the indication can be included in a downlink control information (DCI) format.
For one instance, the indication can be included in a DCI format 0_0.
For another instance, the indication can be included in a DCI format 0_1.
For yet another instance, the indication can be included in a DCI format 0_2.
For yet another instance, the indication can be included in a DCI format 1_0.
For yet another instance, the indication can be included in a DCI format 1_1.
For yet another instance, the indication can be included in a DCI format 1_2.
For yet another instance, the indication can be included in a DCI format 2_0.
For yet another instance, the indication can be included in a DCI format 2_1.
For yet another instance, the indication can be included in a DCI format 2_2.
For yet another instance, the indication can be included in a DCI format 2_3.
For yet another instance, the indication can be included in a DCI format 2_4.
For yet another instance, the indication can be included in a DCI format 2_5.
For yet another instance, the indication can be included in a DCI format 2_6.
For yet another instance, the indication can be included in a DCI format 2_7.
For yet another instance, the indication can be included in a DCI format 2_8.

FIG. 8 illustrates a flowchart of an example UE procedure 800 for resource determination according to embodiments of the present disclosure. For example, UE procedure 800 for resource determination can be performed by the UE 116 of FIG. 3. This example is for illustration only and other embodiments can be used without departing from the scope of the present disclosure.

The procedure begins in 801, a UE receives indication on LP-SS transmission. In 802, the UE determines resources for LP-SS transmission based on the indication. In 803, the UE determines resources for other signal or channel based on the resources for LP-SS transmission.

In one embodiment, resource allocation of a signal or channel can be based on the indication of LP-SS transmission, wherein the indication of the LP-SS transmission is according to examples of this disclosure.

In one example, for an unpaired spectrum, a PRACH occasion in a PRACH slot is valid if at least one of the following conditions is satisfied:
1. The UE is not provided with a time division duplexing (TDD) configuration (e.g., tdd-UL-DL-ConfigurationCommon);
2. The PRACH occasion does not precede a LP-SS in the PRACH slot and starts at least N′_gap symbols after a last symbol of the LP-SS, wherein the transmission of the LP-SS is provided by the indication as described in the example of this disclosure;
3. The PRACH occasion does not precede a SS/PBCH block in the PRACH slot and starts at least N_gap symbols after a last symbol of the SS/PBCH block, wherein the transmission of the SS/PBCH block is provided by ssb-PositionsInBurst.

In another example, for an unpaired spectrum, a PRACH occasion in a PRACH slot is valid if at least one of the following conditions is satisfied:
1. The UE is provided with a TDD configuration (e.g., tdd-UL-DL-ConfigurationCommon);
2. The PRACH occasion is within UL symbols;
3. The PRACH occasion does not precede a LP-SS in the PRACH slot and starts at least N′_gap symbols after a last symbol of the LP-SS, wherein the transmission of the LP-SS is provided by the indication as described in the example of this disclosure;
4. The PRACH occasion does not precede a SS/PBCH block in the PRACH slot and starts at least N_gap symbols after a last symbol of the SS/PBCH block, wherein the transmission of the SS/PBCH block is provided by ssb-PositionsInBurst.

For one further evaluation, N′_gap can be same as N_gap. For another further evaluation, N′_gap can be determined based on a subcarrier spacing (SCS) of the PRACH, and no less than N_gap. For yet another further evaluation, N′_gap can be a fixed value, e.g., N′_gap=0.

In one example, for an unpaired spectrum, a PUSCH occasion in a PUSCH slot is valid if at least one of the following conditions is satisfied:
1. The PUSCH occasion does not overlap in time and frequency with any valid PRACH occasion associated with either a Type-1 random access procedure or a Type-2 random access procedure;
2. The UE is not provided with a TDD configuration (e.g., tdd-UL-DL-ConfigurationCommon);
3. The PUSCH occasion does not precede a LP-SS in the PUSCH slot and starts at least N′_gap symbols after a last symbol of the LP-SS, wherein the transmission of the LP-SS is provided by the indication as described in the example of this disclosure;
4. The PUSCH occasion does not precede a SS/PBCH block in the PUSCH slot and starts at least N_gap symbols after a last symbol of the SS/PBCH block, wherein the transmission of the SS/PBCH block is provided by ssb-PositionsInBurst.

In another example, for an unpaired spectrum, a PUSCH occasion in a PUSCH slot is valid if at least one of the following conditions is satisfied:
1. The PUSCH occasion does not overlap in time and frequency with any valid PRACH occasion associated with either a Type-1 random access procedure or a Type-2 random access procedure;
2. The UE is provided with a TDD configuration (e.g., tdd-UL-DL-ConfigurationCommon);
3. The PUSCH occasion is within UL symbols;
4. The PUSCH occasion does not precede a LP-SS in the PUSCH slot and starts at least N′_gap symbols after a last symbol of the LP-SS, wherein the transmission of the LP-SS is provided by the indication as described in the example of this disclosure;
5. The PUSCH occasion does not precede a SS/PBCH block in the PUSCH slot and starts at least N_gap symbols after a last symbol of the SS/PBCH block, wherein the transmission of the SS/PBCH block is provided by ssb-PositionsInBurst.

For one further evaluation, N′_gap can be same as N_gap. For another further evaluation, N′_gap can be determined based on a SCS of the PRACH, and no less than N_gap. For yet another further evaluation, N′_gap can be a fixed value, e.g., N′_gap=0.

For one example, for unpaired spectrum operation, the UE determines the N_{PUSCH}^{repeat} slots as the first N_{PUSCH}^{repeat} slots starting from slot n+k₂+Δ where a repetition of the PUSCH transmission does not include a symbol indicated as downlink by tdd-UL-DL-ConfigurationCommon, or indicated as a symbol of an SS/PBCH block with index provided by ssb-PositionsInBurst, or indicated as a symbol of LP-SS, wherein the transmission of the LP-SS is provided by an indication according to examples of this disclosure.

For one example, if a UE is provided sps-HARQ-Deferral and, after performing the procedures to resolve overlapping among physical uplink control channels (PUCCHs) and PUSCHs in a first slot, if any, the UE determines a PUCCH resource for a PUCCH transmission with first hybrid automatic repeat request acknowledgement (HARQ-ACK) information bits for semi-persistent scheduling (SPS) PDSCH receptions that the UE would report for a first time, and the PUCCH resource
is provided by SPS-PUCCH-AN-List, or by n1PUCCH-AN if SPS-PUCCH-AN-List is not provided
is not cancelled by an overlapping PUCCH or PUSCH transmission of larger priority index
overlaps with a symbol indicated as downlink by tdd-UL-DL-ConfigurationCommon or tdd-UL-DL-ConfigDedicated, or indicated for a SS/PBCH block by ssb-PositionsInBurst, or belonging to a CORESET associated with a Type0-PDCCH common search space (CSS) set, or indicated for a LP-SS transmission by an indication according to examples of this disclosure

### the UE

determines an earliest second slot and, after performing the procedures to determine a PUCCH with HARQ-ACK information bits including second HARQ-ACK information bits and then performing the procedures to resolve overlapping among PUCCHs and PUSCHs, if any, a PUSCH or a PUCCH in the earliest second slot to multiplex HARQ-ACK information bits that include second HARQ-ACK information bits from the first HARQ-ACK information bits, where the second HARQ-ACK information bits correspond to SPS PDSCH configurations with sps-HARQ-Deferral values that are larger than or equal to a time difference, with reference to slots for PUCCH transmissions on the primary cell, between the second slot and the slot of the SPS PDSCH reception, if any
if the UE detects a DCI format in a PDCCH reception that triggers a PUCCH transmission with a Type-3 HARQ-ACK codebook in a slot as described in clause 9.1.4, the UE stops the procedure to determine the earliest second slot in the slot
if the UE is provided a periodic cell switching pattern for PUCCH transmissions by pucch-sSCellPattern, the UE determines the earliest second slot and a corresponding cell based on the periodic cell switching pattern
if the UE multiplexes the second HARQ-ACK information in a PUSCH, or in a PUCCH using a resource that is not from SPS-PUCCH-AN-List, or from n1PUCCH-AN if SPS-PUCCH-AN-List is not provided, the UE stops the procedure to determine the earliest second slot in the slot
if the UE multiplexes the second HARQ-ACK information in a first PUCCH using a resource provided by SPS-PUCCH-AN-List, or by n1PUCCH-AN if SPS-PUCCH-AN-List is not provided, of smaller priority index and the UE drops the first PUCCH transmission due to an overlapping with a second PUSCH or PUCCH transmission of larger priority index, the UE stops the procedure to determine the earliest second slot in the slot
if the UE multiplexes the second HARQ-ACK information in a first PUCCH using a resource provided by SPS-PUCCH-AN-List, or by n1PUCCH-AN if SPS-PUCCH-AN-List is not provided, and the PUCCH transmission is not dropped due to an overlapping with a PUSCH or PUCCH transmission of larger priority and does not have any symbol that overlaps with a symbol indicated as downlink by tdd-UL-DL-ConfigurationCommon or tdd-UL-DL-ConfigDedicated, or indicated for a SS/PBCH block by ssb-PositionsInBurst, or belonging to a CORESET associated with a Type0-PDCCH CSS set, or indicated for a LP-SS transmission by an indication according to examples of this disclosure, the UE stops the procedure to determine the earliest second slot in the slot
the second HARQ-ACK information bits are appended in a HARQ-ACK codebook the UE generates
if the UE would receive a PDSCH providing a transport block (TB) for a same HARQ process as a HARQ-ACK information bit from the second HARQ-ACK information bits prior to transmitting the PUCCH or the PUSCH, the UE does not include the HARQ-ACK information bit in the HARQ-ACK information bits.

For one example, for monitoring of a PDCCH candidate by a UE, the UE is not required to monitor the PDCCH candidate if at least one of the following conditions is satisfied:
1. The UE has received the indication on the LP-SS transmission, as described in the example of this disclosure;
2. The UE does not monitor PDCCH candidates in a Type0-PDCCH CSS set;
3. At least one RE for a PDCCH candidate overlaps with at least one RE of the LP-SS transmission provided by the indication according to examples of this disclosure.

For another example, for monitoring of a PDCCH candidate by a UE, the UE is not required to monitor the PDCCH candidate if at least one of the following conditions is satisfied:
1. The UE has received the indication on the LP-SS transmission, as described in the example of this disclosure;
2. At least one RE for a PDCCH candidate overlaps with at least one RE of the LP-SS transmission provided by the indication according to examples of this disclosure.

For yet another example, if a UE monitors the PDCCH candidate for a Type0-PDCCH CSS set on the serving cell, the UE may expect that no LP-SS is transmitted in REs used for monitoring the PDCCH candidate on the serving cell.

For one example, when receiving the PDSCH scheduled with system information radio network temporary identifier (SI-RNTI) and the system information indicator in DCI is set to 0, the UE shall expect that no LP-SS is transmitted in REs used by the UE for a reception of the PDSCH.

For another example, when receiving the PDSCH scheduled with SI-RNTI and the system information indicator in DCI is set to 1, random access RNTI (RA-RNTI), MSGB-RNTI, paging (P-RNTI) or temporary cell RNTI (TC-RNTI), the UE expects LP-SS transmission by indication according to examples of disclosure, and if the PDSCH resource allocation overlaps with PRBs (or REs) containing LP-SS transmission resources, the UE shall expect that the PRBs (or REs) containing LP-SS transmission resources are not available for PDSCH in the OFDM symbols where LP-SS is transmitted.

For yet another example, when receiving PDSCH scheduled by PDCCH with cyclic redundancy check (CRC) scrambled by cell RNTI (C-RNTI), modulation and coding scheme (MCS)-C-RNTI, configured scheduling RNTI (CS-RNTI), group RNTI (G-RNTI), G-CS-RNTI, multicast control channel RNTI (MCCH-RNTI) or PDSCHs with SPS, the REs corresponding to the configured or dynamically indicated resources are not available for PDSCH. Furthermore, the UE expects LP-SS transmission by indication according to examples of disclosure, if the PDSCH resource allocation overlaps with PRBs (or REs) containing LP-SS transmission resources, the UE shall expect that the PRBs (or REs) containing LP-SS transmission resources are not available for PDSCH in the OFDM symbols where LP-SS associated with the same physical cell ID (PCI) is transmitted.

For one example, when the UE is scheduled with multiple PUSCHs on a serving cell by a DCI, HARQ process ID indicated by this DCI applies to the first PUSCH not overlapping with a DL symbol indicated by tdd-UL-DL-ConfigurationCommon or tdd-UL-DL-ConfigurationDedicated if provided, or a symbol of an SS/PBCH block with index provided by ssb-PositionsInBurst, or a symbol of a LP-SS transmission by indication according to examples of disclosure, HARQ process ID is then incremented by 1 for each subsequent PUSCH(s) in the scheduled order, with modulo operation of nrofHARQ-ProcessesForPUSCH applied if nrofHARQ-ProcessesForPUSCH is provided, or with modulo operation of nrofHARQ-ProcessesForPUSCH-r17 applied if nrofHARQ-ProcessesForPUSCH-r17 is provided, or with modulo operation of 16 applied, otherwise. HARQ process ID is not incremented for PUSCH(s) not transmitted if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst, or a symbol of a LP-SS transmission by indication according to examples of disclosure.

For another example, for unpaired spectrum:
When AvailableSlotCounting is enabled, and in case K>1, the UE determines N·K slots for a PUSCH transmission of a PUSCH repetition type A scheduled by DCI format 0_1 or 0_2, based on tdd-UL-DL-ConfigurationCommon, tdd-UL-DL-ConfigurationDedicated, ssb-PositionsInBurst, or the indication of the LP-SS transmission according to examples of disclosure, and the time domain resource assignment (TDRA) information field value in the DCI format 01 or 0_2.
   A slot is not counted in the number of N·K slots for PUSCH transmission of a PUSCH repetition Type A scheduled by DCI format 0_1 or 0_2 if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst, or a symbol of a LP-SS transmission provided by indication according to examples of disclosure.
Otherwise, the UE determines N·K consecutive slots for a PUSCH transmission of a PUSCH repetition type A scheduled by DCI format 0_1 or 0_2, based on the TDRA information field value in the DCI format 0_1 or 0_2.
The UE determines N·K slots for a PUSCH transmission of TB processing over multiple slots scheduled by DCI format 0_1 or 0_2, based on tdd-UL-DL-ConfigurationCommon, tdd-UL-DL-ConfigurationDedicated, ssb-PositionsInBurst, or the indication of the LP-SS transmission according to examples of disclosure, and the TDRA information field value in the DCI format 01 or 0_2.
   A slot is not counted in the number of N·K slots for a PUSCH transmission of TB processing over multiple slots if at least one of the symbols indicated by the indexed row of the used resource allocation table in the slot overlaps with a DL symbol indicated by tdd-UL-DL-ConfigurationCommon or tdd-UL-DL-ConfigurationDedicated if provided, or a symbol of an SS/PBCH block with index provided by ssb-PositionsInBurst, or a symbol of a LP-SS transmission provided by indication according to examples of disclosure.
The UE determines N·K slots for a PUSCH transmission of a PUSCH repetition Type A scheduled by random access response (RAR) UL grant, based on tdd-UL-DL-ConfigurationCommon, ssb-PositionsInBurst, or the indication of the LP-SS transmission according to examples of disclosure, and the TDRA information field value in the RAR UL grant.
   A slot is not counted in the number of N·K slots for a PUSCH transmission of a PUSCH repetition Type A scheduled by RAR UL grant, if at least one of the symbols indicated by the indexed row of the used resource allocation table in the slot overlaps with a DL symbol indicated by tdd-UL-DL-ConfigurationCommon if provided, or a symbol of an SS/PBCH block with index provided by ssb-PositionsInBurst, or a symbol of the LP-SS transmission provided by indication according to examples of disclosure.
The UE determines N·K slots for a PUSCH transmission of a PUSCH repetition Type A scheduled by DCI format 0_0 with CRC scrambled by TC-RNTI, based on tdd-UL-DL-ConfigurationCommon, ssb-PositionsInBurst, or the indication of the LP-SS transmission according to examples of disclosure, and the TDRA information field value in the DCI scheduling the PUSCH.
   A slot is not counted in the number of N·K slots for a PUSCH transmission of a PUSCH repetition Type A scheduled by DCI format 0_0 scrambled by TC-RNTI, if at least one of the symbols indicated by the indexed row of the used resource allocation table in the slot overlaps with a DL symbol indicated by tdd-UL-DL-ConfigurationCommon if provided, or a symbol of an SS/PBCH block with index provided by ssb-PositionsInBurst or a symbol of a LP-SS transmission provided by an indication according to examples of disclosure.

For yet another example, for paired spectrum and supplementary uplink (SUL) band:
The UE determines N·K consecutive slots for a PUSCH transmission of a PUSCH repetition type A scheduled by DCI format 0_1 or 0_2, or 0_3 for paired spectrum only, or for a PUSCH transmission of TB processing over multiple slots scheduled by DCI format 0_1 or 0_2, based on the TDRA information field value in the DCI format 0_1, 0_2 or 0_3.
For the case of a reduced capability half-duplex UE, the UE determines N·K slots for a PUSCH transmission of a PUSCH repetition type A scheduled by DCI format 0_1 or 0_2 when AvailableSlotCounting is enabled and K>1, or for a PUSCH transmission of TB processing over multiple slots scheduled by DCI format 0_1 or 0_2, based on the TDRA information field value in the DCI format 0_1 or 0_2. A slot is not counted in the number of N·K slots if at least one of the symbols indicated by the indexed row of the used resource allocation table in the slot does not start or end at least N_{Rx-Tx}·T_{c} or N_{Tx-Rx}·T_{c}, respectively, from the last or first symbol of an SS/PBCH block with index provided by ssb-PositionsInBurst, or from the last or first symbol of a LP-SS provided by an indication according to examples of disclosure.
The UE determines N·K consecutive slots for a PUSCH transmission of a PUSCH repetition Type A scheduled by RAR UL grant, based on the TDRA information field value in the RAR UL grant.
The UE (e.g., the UE 116) determines N·K consecutive slots for a PUSCH transmission of a PUSCH repetition Type A scheduled by DCI format 0_0 with CRC scrambled by TC-RNTI, based on the TDRA information field value in the DCI scheduling the PUSCH.

In one embodiment, with reference to FIG. 8, an example UE procedure for illustrating the indication of LP-SS transmission and corresponding resource allocation for other signal or channel is shown.

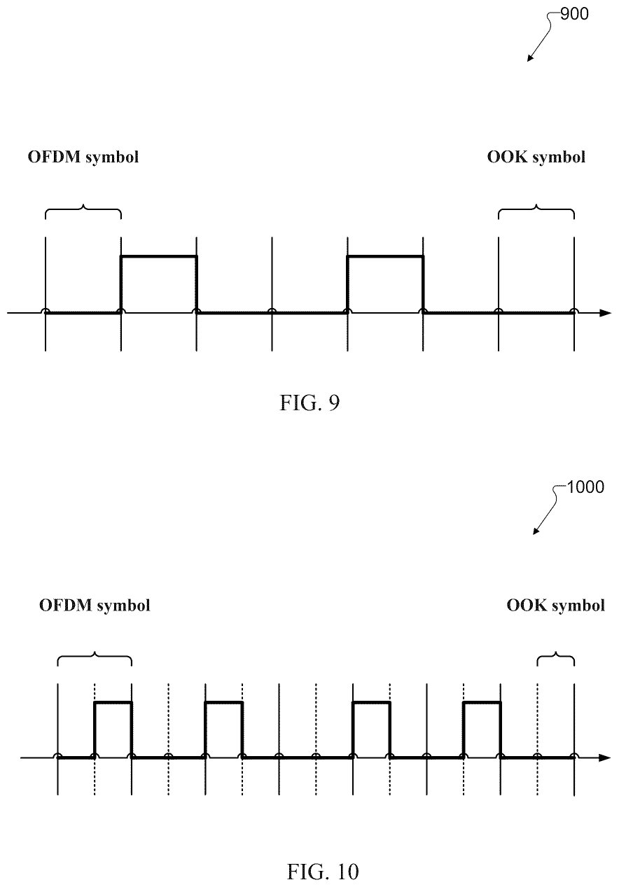

FIG. 9 illustrates a diagram of an example OOK waveform 900 according to embodiments of the present disclosure. For example, OOK waveform 900 can be utilized by any of the UEs 111-116 of FIG. 1, such as the UE 114. This example is for illustration only and other embodiments can be used without departing from the scope of the present disclosure.

FIG. 10 illustrates a diagram of an example OOK waveform 1000 according to embodiments of the present disclosure. For example, OOK waveform 1000 can be utilized by any of the UEs 111-116 of FIG. 1, such as the UE 115. This example is for illustration only and other embodiments can be used without departing from the scope of the present disclosure.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new DCI format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, the UE still needs to frequently wake up to monitor the new DCI format or the PEI, such that the radio of the UE cannot be fully turned off for a long duration. To avoid such situation and to acquire further power saving gain, an additional receiver radio is considered, wherein the additional receiver radio can be used for monitoring a particular set of signals with very low power consumption, and the main receiver radio can be turned off or operating with a very lower power for a long duration.

This disclosure provides for the sequence design of the low power signals that could be received with low power, e.g., with a waveform enables reception using an additional receiver radio. For example, the low power signals can include a low power synchronization signal (LP-SS), e.g., a low power signal for synchronization with the low power receiver, and an on-off-key (OOK) waveform can be used for the LP-SS. In the OOK waveform, one OFDM symbol can include one or multiple OOK symbols (as illustrated in FIG. 9 and FIG. 10), and each OOK symbol can correspond to either ON or OFF waveform/symbol in the time domain. The ON-OFF pattern in the time domain can be carried by a binary sequence, and this disclosure provides for the binary sequence design for LP-SS.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

When low power signal(s) includes multiple types of signals, each type of the signal can be according to examples in this disclosure jointly or separately.

This disclosure provides for the sequence design of the low power synchronization signal. More precisely, the following aspects are included in the disclosure:
Mapping of the binary sequence for LP-SS
   Same value for L_{LP-SS} and same value for N_{LP-SS}^{OOK}
   Same value for L_{LP-SS} and different value for N_{LP-SS}^{OOK}
   Different value for L_{LP-SS} and different value for N_{LP-SS}^{OOK}
Sequence generation method for the binary sequence for LP-SS
   Maximum length (M)-sequence based generation method
   pseudo-noise (PN)-sequence based generation method
Example UE procedure

In one embodiment, the ON-OFF pattern in the time domain can be determined by at least one binary sequence. For instance, one OOK symbol can correspond to one bit in the at least one binary sequence, and the bit taking a value of 1 (or +1) corresponds to that the OOK symbol is ON and the bit taking a value of 0 (or −1) corresponds to that the OOK symbol is OFF.

In the rest of the disclosure, the following notations are used:
L_{LP-SS}: a length of the binary sequence that determines the ON-OFF pattern of the LP-SS. For instance, this parameter can be provided by a higher layer parameter.
N_{LP-SS}^{OOK}: a number of OOK symbols that is used for LP-SS. For one instance, N_{LP-SS}^{OOK}=M·N_{LP-SS}^{OOK}, wherein M is a number of OOK symbols in a OFDM symbol. For another instance, this parameter can be provided by a higher layer parameter.
N_{LP-SS}^{OOK}: a number of OFDM symbols that is used for LP-SS. For one instance, N_{LP-SS}^{OOK}=N_{LP-SS}^{OOK}/M, wherein M is a number of OOK symbols in a OFDM symbol (e.g., provided by a higher layer parameter). For another instance, N_{LP-SS}^{OOK}=┌N_{LP-SS}^{OOK}/M┐, wherein M is a number of OOK symbols in a OFDM symbol. For instance, this parameter can be provided by a higher layer parameter.
N_{LP-SS}: a number of binary sequences for the LP-SS. For instance, this parameter can be provided by a higher layer parameter.

At least one of the examples of this embodiment can be supported for LP-SS, and when multiple examples of this embodiment are supported, a configuration (e.g., a higher layer parameter, such as system information block) can be used for indicating which example is used for a UE. For one further evaluation, the configuration can be cell-specific.

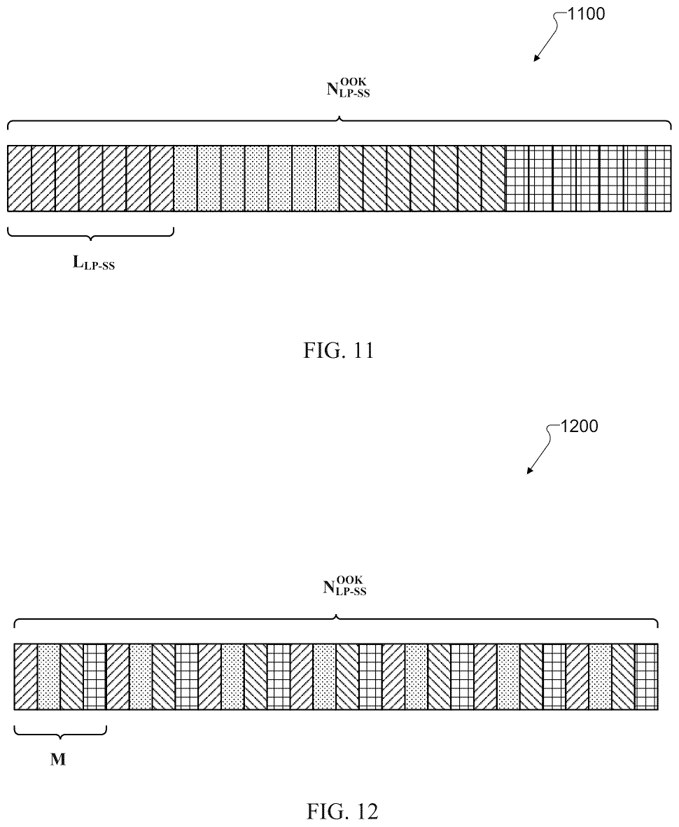

FIG. 11 illustrates a diagram of example binary sequences 1100 according to embodiments of the present disclosure. For example, binary sequences 1100 can be utilized by any of the UEs 111-116 of FIG. 1, such as the UE 111. This example is for illustration only and other embodiments can be used without departing from the scope of the present disclosure.

FIG. 12 illustrates a diagram of example binary sequences 1200 according to embodiments of the present disclosure. For example, binary sequences 1200 can be utilized by any of the UEs 111-116 of FIG. 1, such as the UE 112. This example is for illustration only and other embodiments can be used without departing from the scope of the present disclosure.

For one example, for supported OOK waveforms regarding the number of OOK symbols in a OFDM symbol, the number of OOK symbols is same, and a unified length of the binary sequence can be used, e.g., a same value of L_{LP-SS} and a same value of N_{LP-SS}^{OOK} are used for supported values of M (e.g., M∈{1, 2, 4}).

For one sub-example, L_{LP-SS}=N_{LP-SS}^{OOK}, and the binary sequence is used for determining the ON-OFF pattern of the OOK waveform, wherein the k-th value of the binary sequence is used for determining the k-th OOK waveform, and 1≤k≤N_{LP-SS}^{OOK}.

For another sub-example, L_{LP-SS}=N_{LP-SS}^{OOK}, and the binary sequence is used for determining the ON-OFF pattern of the OOK waveform, wherein the k-th value of the binary sequence is used for determining the (N_{LP-SS}^{OOK}−k+1)-th OOK waveform, and 1≤k≤N_{LP-SS}^{OOK}.

For one sub-example, L_{LP-SS}>N_{LP-SS}^{OOK}, and the binary sequence is truncated to the first N_{LP-SS}^{OOK} values, and used for determining the ON-OFF pattern of the OOK waveform. For one instance, the k-th value of the binary sequence is used for determining the k-th OOK waveform, and 1≤k≤N_{LP-SS}^{OOK}. For another instance, the k-th value of the binary sequence is used for determining the (N_{LP-SS}^{OOK}−k+1)-th OOK waveform, and 1≤k≤N_{LP-SS}^{OOK}.

For another sub-example, L_{LP-SS}>N_{LP-SS}^{OOK}, and the binary sequence is truncated to the last N_{LP-SS}^{OOK} values, and used for determining the ON-OFF pattern of the OOK waveform. For one instance, the (L_{LP-SS}−N_{LP-SS}^{OOK}+k)-th value of the binary sequence is used for determining the k-th OOK waveform, and 1≤k≤N_{LP-SS}^{OOK}. For another instance, the (L_{LP-SS}−N_{LP-SS}^{OOK}+k)-th value of the binary sequence is used for determining the (N_{LP-SS}^{OOK}−k+1)-th OOK waveform, and 1≤k≤N_{LP-SS}^{OOK}.

For one sub-example, L_{LP-SS}<N_{LP-SS}^{OOK}, and the binary sequence followed by another binary sequence with a length (N_{LP-SS}^{OOK}−L_{LP-SS}) is used for determining the ON-OFF pattern of the OOK waveform. For one instance, the k-th value of the binary sequence followed by the other binary sequence is used for determining the k-th OOK waveform, and 1≤k≤N_{LP-SS}^{OOK}. For another instance, the k-th value of the binary sequence followed by the other binary sequence is used for determining the (N_{LP-SS}^{OOK}−k+1)-th OOK waveform, and 1≤k≤N_{LP-SS}^{OOK}. For one instance, the other binary sequence is a fixed sequence, such as an all-zero sequence, or an all-one sequence. For another instance, the other binary sequence is repeated from the binary sequence, such as the first (N_{LP-SS}^{OOK}−L_{LP-SS}) bits of the binary sequence, or the last (N_{LP-SS}^{OOK}−L_{LP-SS}) bits of the binary sequence. For yet another instance, the other binary sequence is configured by the gNB, such as by a higher layer parameter.

For another sub-example, L_{LP-SS}<N_{LP-SS}^{OOK}, and the binary sequence following another binary sequence with a length (N_{LP-SS}^{OOK}−L_{LP-SS}) is used for determining the ON-OFF pattern of the OOK waveform. For one instance, the k-th value of the binary sequence followed by the other binary sequence is used for determining the k-th OOK waveform, and 1≤k≤N_{LP-SS}^{OOK}. For another instance, the k-th value of the binary sequence followed by the other binary sequence is used for determining the (N_{LP-SS}^{OOK}−k+1)-th OOK waveform, and 1≤k≤N_{LP-SS}^{OOK}. For one instance, the other binary sequence is a fixed sequence, such as an all-zero sequence, or an all-one sequence. For another instance, the other binary sequence is repeated from the binary sequence, such as the first (N_{LP-SS}^{OOK}−L_{LP-SS}) bits of the binary sequence, or the last (N_{LP-SS}^{OOK}−L_{LP-SS}) bits of the binary sequence. For yet another instance, the other binary sequence is configured by the gNB, such as by a higher layer parameter.

For another example, for a supported OOK waveforms regarding the number of OOK symbols in a OFDM symbol, the number of OOK symbols may be different, and a unified length of the binary sequence can be used, e.g., a same value of L_{LP-SS} and a different value of N_{LP-SS}^{OOK} are used for supported values of M {e.g., M∈{1, 2, 4}}.

For one sub-example, the value of N_{LP-SS}^{OOK} can be scaled with the value of M. For one instance, denoting the value of N_{LP-SS}^{OOK} for M=1 as N_{LP-SS}^{OOK}(1), then the value of N_{LP-SS}^{OOK} for M (e.g., denoted as N_{LP-SS}^{OOK}(M)) is N_{LP-SS}^{OOK}(M)=M N_{LP-SS}^{OOK}(1), wherein e.g., M=1, 2, 4, . . . . The maximum supported value for M can be denoted as Mₘₐₓ, e.g., Mₘₐₓ=4. The value N_{LP-SS}^{OOK}(1)=4, or 6 or 8. For another instance, N_{LP-SS}^{OOK}(1)=7, and N_{LP-SS}^{OOK}(M)=8 for M=2, 4, . . . .

For one sub-example, L_{LP-SS}≥N_{LP-SS}^{OOK}(Mₘₐₓ), and the binary sequence is truncated to the first N_{LP-SS}^{OOK}(M) values, and used for determining the ON-OFF pattern of the OOK waveform with respect to the value of M. For one instance, the k-th value of the binary sequence is used for determining the k-th OOK waveform, and 1≤k≤N_{LP-SS}^{OOK}(M). For another instance, the k-th value of the binary sequence is used for determining the (N_{LP-SS}^{OOK}(M)−k+1)-th OOK waveform, and 1≤k≤N_{LP-SS}^{OOK}(M).

For another sub-example, L_{LP-SS}≥N_{LP-SS}^{OOK}(Mₘₐₓ), and the binary sequence is truncated to the last N_{LP-SS}^{OOK}(M) values, and used for determining the ON-OFF pattern of the OOK waveform with respect to the value of M. For one instance, the (L_{LP-SS}−N_{LP-SS}^{OOK}(M)+k)-th value of the binary sequence is used for determining the k-th OOK waveform, and 1≤k≤N_{LP-SS}^{OOK}(M). For another instance, the (L_{LP-SS}−N_{LP-SS}^{OOK}(M)+k)-th value of the binary sequence is used for determining the (N_{LP-SS}^{OOK}−k+1)-th OOK waveform, and 1≤k≤N_{LP-SS}^{OOK}(M).

For one sub-example, L_{LP-SS}=N_{LP-SS}^{OOK}(1), and the binary sequence is repeated for M times and then used for determining the ON-OFF pattern of the OOK waveform with respect to the value of M, wherein there could be different cyclic shift, initial condition, or phase rotation applied to the repetitions. For one instance (as illustrated in FIG. 11), the M repetitions of the binary sequences can be concatenated in the time domain, e.g., the k-th value of the m-th binary sequence is used for determining the ((m−1)·L_{LP-SS}+k)-th OOK waveform, and 1≤k≤L_{LP-SS} and 1≤m≤M. For another instance (as illustrated in FIG. 12), the M repetitions of the binary sequences can be interleaved in the time domain, e.g., the k-th value of the m-th binary sequence is used for determining the ((k−1)·M+m)-th OOK waveform, and 1≤k≤L_{LP-SS} and 1≤m≤M. For one instance, when the sequence for LP-SS is a M-sequence, the cyclic shifts for the M repetitions can be different, e.g., M different cyclic shifts are used for the M repetitions.

For one sub-example, L_{LP-SS}<N_{LP-SS}^{OOK}(1), and the binary sequence is repeated for M times and followed by another binary sequence, and then used for determining the ON-OFF pattern of the OOK waveform with respect to the value of M, wherein there could be different cyclic shift, initial condition, or phase rotation applied to the repetitions. For one instance, the M repetitions of the binary sequences can be concatenated in the time domain, and then followed by another binary sequence with length M·(N_{LP-SS}^{OOK}(1)−L_{LP-SS}). For another instance, the M repetitions of the binary sequences can be each followed by another binary sequence with length (N_{LP-SS}^{OOK}(1)−L_{LP-SS}), and then concatenated in the time domain. For yet another instance, the M repetitions of the binary sequences can be interleaved in the time domain, and then followed by another binary sequence with length M·(N_{LP-SS}^{OOK}(1)−L_{LP-SS}). For yet another instance, the M repetitions of the binary sequences can be each followed by another binary sequence with length (N_{LP-SS}^{OOK}(1)−L_{LP-SS}), and then interleaved in the time domain. For one instance, the other binary sequence is a fixed sequence, such as an all-zero sequence, or an all-one sequence. For another instance, the other binary sequence is repeated from the binary sequence, such as the first corresponding number of bits of the binary sequence, or the last corresponding number of bits of the binary sequence. For yet another instance, the other binary sequence is configured by the gNB, such as by a higher layer parameter.

For yet another example, for a supported OOK waveforms regarding the number of OOK symbols in a OFDM symbol, the number of OOK symbols is unique, and a corresponding length of the binary sequence can be used, e.g., a different value of L_{LP-SS} and a different value of N_{LP-SS}^{OOK} are used for supported values of M, {e.g., M∈{1, 2, 4}}.

For one sub-example, the value of N_{LP-SS}^{OOK} can be scaled with the value of M. For instance, denoting the value of N_{LP-SS}^{OOK} for M=1 as N_{LP-SS}^{OOK}(1), then the value of N_{LP-SS}^{OOK} for M (e.g., denoted as N_{LP-SS}^{OOK}(M)) is N_{LP-SS}^{OOK}(M)=M·N_{LP-SS}^{OOK}(1), wherein e.g., M=1, 2, 4, . . . . The maximum supported value for M can be denoted as Mₘₐₓ, e.g., Mₘₐₓ=4. The value N_{LP-SS}^{OOK}(1)=4, or 6 or 8. For another instance, N_{LP-SS}^{OOK}(1)=7, and N_{LP-SS}^{OOK}(M)=8 for M=2, 4, . . . .

For one sub-example, the value of L_{LP-SS} can be determined based on the value of M. For one instance, denoting the value of L_{LP-SS} for M=1 as L_{LP-SS}(1), then the value of L_{LP-SS} for M (e.g., denoted as L_{LP-SS}(M)) is L_{LP-SS}(M)=M·L_{LP-SS}(1), wherein e.g., M=1, 2, 4, . . . . For another instance, L_{LP-SS}(2·M)=2·L_{LP-SS}(M)+1, wherein e.g., M=1, 2, 4, . . . .

For one sub-example, L_{LP-SS}(M)=N_{LP-SS}^{OOK}(M), and the binary sequence is used for determining the ON-OFF pattern of the OOK waveform, wherein the k-th value of the binary sequence is used for determining the k-th OOK waveform, and 1≤k≤N_{LP-SS}^{OOK}(M).

For another sub-example, L_{LP-SS}(M)=N_{LP-SS}^{OOK}(M), and the binary sequence is used for determining the ON-OFF pattern of the OOK waveform, wherein the k-th value of the binary sequence is used for determining the (N_{LP-SS}^{OOK}(M)−k+1)-th OOK waveform, and 1≤k≤N_{LP-SS}^{OOK}(M).

For one sub-example, L_{LP-SS}(M)>N_{LP-SS}^{OOK}(M), and the binary sequence is truncated to the first N_{LP-SS}^{OOK}(M) values, and used for determining the ON-OFF pattern of the OOK waveform. For one instance, the k-th value of the binary sequence is used for determining the k-th OOK waveform, and 1≤k≤N_{LP-SS}^{OOK}(M). For another instance, the k-th value of the binary sequence is used for determining the (N_{LP-SS}^{OOK}(M)−k+1)-th OOK waveform, and 1≤k≤N_{LP-SS}^{OOK}(M).

For another sub-example, L_{LP-SS}(M)>N_{LP-SS}^{OOK}(M), and the binary sequence is truncated to the last N_{LP-SS}^{OOK}(M) values, and used for determining the ON-OFF pattern of the OOK waveform. For one instance, the (L_{LP-SS}(M)−N_{LP-SS}^{OOK}(M)+k)-th value of the binary sequence is used for determining the k-th OOK waveform, and 1≤k≤N_{LP-SS}^{OOK}(M). For another instance, the (L_{LP-SS}(M)−N_{LP-SS}^{OOK}(M)+k)-th value of the binary sequence is used for determining the (N_{LP-SS}^{OOK}(M)−k+1)-th OOK waveform, and 1≤k≤N_{LP-SS}^{OOK}(M).

For one sub-example, L_{LP-SS}(M)<N_{LP-SS}^{OOK}(M), and the binary sequence followed by another binary sequence with a length (N_{LP-SS}^{OOK} (M)−L_{LP-SS}(M)) is used for determining the ON-OFF pattern of the OOK waveform. For one instance, the k-th value of the binary sequence followed by the other binary sequence is used for determining the k-th OOK waveform, and 1≤k≤N_{LP-SS}^{OOK}(M). For another instance, the k-th value of the binary sequence followed by the other binary sequence is used for determining the (N_{LP-SS}^{OOK}(M)−k+1)-th OOK waveform, and 1≤k≤N_{LP-SS}^{OOK}(M). For one instance, the other binary sequence is a fixed sequence, such as an all-zero sequence, or an all-one sequence. For another instance, the other binary sequence is repeated from the binary sequence, such as the first (N_{LP-SS}^{OOK}(M)−L_{LP-SS}(M)) bits of the binary sequence, or the last (N_{LP-SS}^{OOK}(M)−L_{LP-SS}(M)) bits of the binary sequence. For yet another instance, the other binary sequence is configured by the gNB, such as by a higher layer parameter.

For another sub-example, L_{LP-SS}(M)<N_{LP-SS}^{OOK}(M), and the binary sequence following another binary sequence with a length (N_{LP-SS}^{OOK}(M)−L_{LP-SS}(M)) is used for determining the ON-OFF pattern of the OOK waveform. For one instance, the k-th value of the binary sequence followed by the other binary sequence is used for determining the k-th OOK waveform, and 1≤k≤N_{LP-SS}^{OOK}(M). For another instance, the k-th value of the binary sequence followed by the other binary sequence is used for determining the (N_{LP-SS}^{OOK}(M)−k+1)-th OOK waveform, and 1≤k≤N_{LP-SS}^{OOK}(M). For one instance, the other binary sequence is a fixed sequence, such as an all-zero sequence, or an all-one sequence. For another instance, the other binary sequence is repeated from the binary sequence, such as the first (N_{LP-SS}^{OOK}(M)−L_{LP-SS}(M)) bits of the binary sequence, or the last (N_{LP-SS}^{OOK}(M)−L_{LP-SS}(M)) bits of the binary sequence. For yet another instance, the other binary sequence is configured by the gNB, such as by a higher layer parameter.

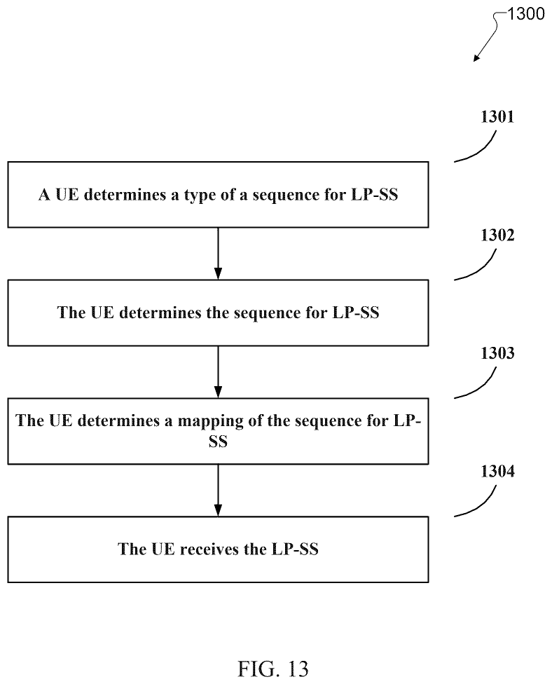

FIG. 13 illustrates a flowchart of an example UE procedure 1300 for determining a LP-SS sequence and receiving the LP-SS according to embodiments of the present disclosure. For example, UE procedure 1300 for determining a LP-SS sequence and receiving the LP-SS can be performed by the UE 116 of FIG. 3. This example is for illustration only and other embodiments can be used without departing from the scope of the present disclosure.

The procedure begins in 1301, a UE determines a type of a sequence for LP-SS. In 1302, the UE determines the sequence for LP-SS. In 1303, the UE determines a mapping of the sequence for LP-SS. In 1304, the UE receives the LP-SS.

In one embodiment, the binary sequence for determining the ON-OFF pattern of LP-SS can be generated according to at least one example of this embodiment. When multiple examples of this embodiment are supported, a configuration (e.g., a higher layer parameter) can be used for indicating which example is used for a UE. For one further evaluation, the configuration can be cell-specific.

For one example, the binary sequence can be a M-sequence, and the binary sequence can be given by x_{LP-SS}(i)=x((i+n_{CS}) mod L_{LP-SS}), with 0≤i≤L_{LP-SS}−1, or by x_{LP-SS}(i)=x((i+n_{CS}) mod L_{LP-SS}(M)), with 0≤i≤L_{LP-SS}(M)−1, wherein n_{CS} is a cyclic shift applied to the binary sequence, which is an integer.

For one sub-example, the M-sequence can be with length 7. For instance, L_{LP-SS}=7, or L_{LP-SS}(M)=7 (e.g., for M=1).

For one further evaluation, a generation method for the M-sequence x(i) can be determined as one from Table 1.

TABLE 1
Example M-sequence generation method with length 7

| | | Corresponding generation method |
|---|---|---|
| Index | Generator polynomial | (i = 0, 1, . . . , 3) |
| 1 | x³ + x² + 1 | x(i + 3) = x(i + 2) + x(i) |
| 2 | x³ + x + 1 | x(i + 3) = x(i + 1) + x(i) |

For another further evaluation, the cyclic shift can be different for the N_{LP-SS} M-sequences, e.g., n_{CS}=n·K, wherein K is an integer, and 0≤n≤N_{LP-SS}−1. For one instance, K=1. For another instance, K=└L_{LP-SS}/N_{LP-SS}┘. For yet another instance, K=┌L_{LP-SS}/N_{LP-SS}┐.

For yet another further evaluation, the cyclic shift can be fixed, e.g., n_{CS}=0.

For yet another further evaluation, the initial condition can be different for the N_{LP-SS} M-sequences, e.g., the initial condition [x(2), x(1), x(0)] can be determined as the 3-bit binary expression of n·K, wherein K is an integer, and 0≤n≤N_{LP-SS}−1. For one instance, K=1. For another instance, K=└L_{LP-SS}/N_{LP-SS}┘. For yet another instance, K=┌L_{LP-SS}/N_{LP-SS}┐.

For yet another further evaluation, the initial condition can be fixed, e.g., [x(2),x(1),x(0)]=[0,0,1].

For another sub-example, the M-sequence can be with length 15. For instance, L_{LP-SS}=15, or L_{LP-SS}(M)=15 (e.g., for M=2).

For one further evaluation, a generation method for the M-sequence x(i) can be determined as one from Table 2.

TABLE 2
Example M-sequence generation method with length 15

| | | Corresponding generation method |
|---|---|---|
| Index | Generator polynomial | (i = 0, 1, . . . , 10) |
| 1 | x⁴ + x³ + 1 | x(i + 4) = x(i + 3) + x(i) |
| 2 | x⁴ + x + 1 | x(i + 4) = x(i + 1) + x(i) |

For another further evaluation, the cyclic shift can be different for the N_{LP-SS} M-sequences, e.g., n_{CS}=n·K, wherein K is an integer, and 0≤n≤N_{LP-SS}−1. For one instance, K=1. For another instance, K=└L_{LP-SS}/N_{LP-SS}┘. For yet another instance, K=┌L_{LP-SS}/N_{LP-SS}┐.

For yet another further evaluation, the cyclic shift can be fixed, e.g., n_{CS}=0.

For yet another further evaluation, the initial condition can be different for the N_{LP-SS} M-sequences, e.g., the initial condition [x(3), x(2), x(1), x(0)] can be determined as the 4-bit binary expression of n·K, wherein K is an integer, and 0≤n≤N_{LP-SS}−1. For one instance, K=1. For another instance, K=└L_{LP-SS}/N_{LP-SS}┘. For yet another instance, K=┌L_{LP-SS}/N_{LP-SS}┐.

For yet another further evaluation, the initial condition can be fixed, e.g., [x(3),x(2),x(1),x(0)]=[0,0,0,1].

For yet another sub-example, the M-sequence can be with length 31. For instance, L_{LP-SS}=31, or L_{LP-SS}(M)=31 (e.g., for M=4).

For one further evaluation, a generation method for the M-sequence x(i) can be determined as one from Table 3.

TABLE 3
Example M-sequence generation method with length 31

| | | Corresponding generation method |
|---|---|---|
| Index | Generator polynomial | (i = 0, 1, . . . , 25) |
| 1 | x⁵ + x³ + 1 | x(i + 5) = x(i + 3) + x(i) |
| 2 | x⁵ + x² + 1 | x(i + 5) = x(i + 2) + x(i) |
| 3 | x⁵ + x⁴ + x³ + x² + 1 | x(i + 5) = x(i + 4) + x(i + 3) + x(i + 2) + x(i) |
| 4 | x⁵ + x³ + x² + x + 1 | x(i + 5) = x(i + 3) + x(i + 2) + x(i + 1) + x(i) |
| 5 | x⁵ + x⁴ + x³ + x + 1 | x(i + 5) = x(i + 4) + x(i + 3) + x(i + 1) + x(i) |
| 6 | x⁵ + x⁴ + x² + x + 1 | x(i + 5) = x(i + 4) + x(i + 2) + x(i + 1) + x(i) |

For another further evaluation, the cyclic shift can be different for the N_{LP-SS} M-sequences, e.g., n_{CS}=n·K, wherein K is an integer, and 0≤n≤N_{LP-SS}−1. For one instance, K=1. For another instance, K=└L_{LP-SS}/N_{LP-SS}┘. For yet another instance, K=┌L_{LP-SS}/N_{LP-SS}┐.

For yet another further evaluation, the cyclic shift can be fixed, e.g., n_{CS}=0.

For yet another further evaluation, the initial condition can be different for the N_{LP-SS} M-sequences, e.g., the initial condition [x(4), x(3), x(2), x(1), x(0)] can be determined as the 4-bit binary expression of n·K, wherein K is an integer, and 0≤n≤N_{LP-SS}−1. For one instance, K=1. For another instance, K=└L_{LP-SS}/N_{LP-SS}┘. For yet another instance, K=┌L_{LP-SS}/N_{LP-SS}┐.

For yet another further evaluation, the initial condition can be fixed, e.g., [x(4),x(3), x(2),x(1),x(0)]=[0, 0, 0, 0, 1].

For one example, the binary sequence can be a pseudo-random-sequence (e.g., PN-sequence), and the binary sequence can be given by

$${x}_{LP - SS} ( n ) = ( {x}_{1} ( n + {N}_{c} ) + {x}_{2} ( x + {N}_{c} ) ) mod 2 , {x}_{1} ( n + 31 ) = ( {x}_{1} ( n + 3 ) + {x}_{1} ( n ) ) mod 2 , {x}_{1} ( n + 31 ) = ( {x}_{1} ( n + 3 ) + {x}_{1} ( n + 2 ) + {x}_{1} ( n + 1 ) + {x}_{1} ( n ) ) mod 2 , {N}_{c} = 1600 , {x}_{1} ( 30 : 0 ) = [ 0 , … , 0 , 1 ] , {c}_{init} = {\sum }_{i = 0}^{30} {x}_{2} ( i ) \cdot {2}^{i} .$$

For one further evaluation, the initial condition cᵢₙᵢₜ can be determined based on a sequence index configured by the gNB.

For another further evaluation, L_{LP-SS}=2³¹−1.

In one embodiment, with reference to FIG. 13, an example UE procedure for determining and receiving the sequence for LP-SS is shown.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters including a system information block (SIB); and
a processor operably coupled to the transceiver, the processor configured to:
identify, based on the SIB, an indication of transmitted synchronization signal and physical broadcast channel (SS/PBCH) blocks in a first burst;
determine, based on the indication, a number of transmissions of a low-power synchronization signal (LP-SS) in a second burst; and
determine, based on the number of the LP-SS transmissions in the second burst, a set of slots including the LP-SS transmissions in the second burst,
wherein the transceiver is further configured to receive the LP-SS based on the set of slots.

2. The UE of claim 1, wherein the number of LP-SS transmissions in the second burst is the same as the number of transmitted SS/PBCH blocks in the first burst.

3. The UE of claim 1, wherein the processor is further configured to identify a n-th slot in the set of slots as 0+U·n, where O is a starting slot and U is a number of slots for a LP-SS transmission in the second burst.

4. The UE of claim 1, wherein the processor is further configured to determine that a k-th LP-SS in the second burst is quasi-co-located (QCLed) with a k-th transmitted SS/PBCH block in the first burst.

5. The UE of claim 1, wherein the processor is further configured to:
determine an on-off-key (OOK) waveform for the LP-SS;
identify, based on the SIB, a number M of OOK symbols in an orthogonal frequency-division multiplexing (OFDM) symbol;
determine a number N_{LP-SS}^{OOK} of OOK symbols for the LP-SS;
determine a number N_{LP-SS}^{OFDM} of OFDM symbols for the LP-SS;
determine a binary sequence for generating the LP-SS; and
determine, based on the binary sequence, the NL_{LP-SS}^{OOK} OOK symbols with the OOK waveform.

6. The UE of claim 5, wherein:
$${N}_{LP - SS}^{OFDM} = \frac{{N}_{LP - SS}^{OOK}}{M} ,$$
and
N_{LP-SS}^{OFDM} is a same value for all carrier spacings of the LP-SS.

7. The UE of claim 5, wherein:
an OOK symbol is an ON symbol when a corresponding bit in the binary sequence is 1, and
the OOK symbol is an OFF symbol when the corresponding bit in the binary sequence is 0.

8. A base station (BS) in a wireless communication system, the BS comprising:
a processor configured to:
determine an indication of transmitted synchronization signal and physical broadcast channel (SS/PBCH) blocks in a first burst;
determine, based on the indication, a number of transmissions of a low-power synchronization signal (LP-SS) in a second burst; and
determine, based on the number of the LP-SS transmissions in the second burst, a set of slots including the LP-SS transmissions in the second burst; and
a transceiver operably coupled to the processor, the transceiver configured to:
transmit a set of higher layer parameters including a system information block (SIB), wherein the SIB includes the indication of transmitted SS/PBCH blocks in the first burst; and
transmit the LP-SS transmissions based on the set of slots.

9. The BS of claim 8, wherein the number of LP-SS transmissions in the second burst is the same as the number of transmitted SS/PBCH blocks in the first burst.

10. The BS of claim 8, wherein the processor is further configured to identify a n-th slot in the set of slots as 0+U·n, where O is a starting slot and U is a number of slots for a LP-SS transmission in the second burst.

11. The BS of claim 8, wherein the processor is further configured to determine that a k-th LP-SS in the second burst is quasi-co-located (QCLed) with a k-th transmitted SS/PBCH block in the first burst.

12. The BS of claim 8, wherein the processor is further configured to:
determine an on-off-key (OOK) waveform for the LP-SS;
determine a number M of OOK symbols in an orthogonal frequency-division multiplexing (OFDM) symbol;
determine a number N_{LP-SS}^{OOK} of OOK symbols for the LP-SS;
determine a number N_{LP-SS}^{OFDM} of OFDM symbols for the LP-SS;
determine a binary sequence for generating the LP-SS; and
generate, based on the binary sequence, the N_{LP-SS}^{OOK} OOK symbols with the OOK waveform.

13. The BS of claim 12, wherein:
$${N}_{LP - SS}^{OFDM} = \frac{{N}_{LP - SS}^{OOK}}{M} ,$$
and
N_{LP-SS}^{OFDM} is a same value for all carrier spacings of the LP-SS.

14. The BS of claim 12, wherein:
an OOK symbol is an ON symbol when a corresponding bit in the binary sequence is 1, and
the OOK symbol is an OFF symbol when the corresponding bit in the binary sequence is 0.

15. A method of a user equipment (UE) in a wireless communication system, the method comprising:
receiving a set of higher layer parameters including a system information block (SIB);
identifying, based on the SIB, an indication of transmitted synchronization signal and physical broadcast channel (SS/PBCH) blocks in a first burst;
determining, based on the indication, a number of transmissions of a low-power synchronization signal (LP-SS) in a second burst;
determining, based on the number of the LP-SS transmissions in the second burst, a set of slots including the LP-SS transmissions in the second burst; and
receiving the LP-SS based on the set of slots.

16. The method of claim 15, wherein the number of LP-SS transmissions in the second burst is the same as the number of transmitted SS/PBCH blocks in the first burst.

17. The method of claim 15 further comprising:
identifying a n-th slot in the set of slots as 0+U·n, where O is a starting slot and U is a number of slots for a LP-SS transmission in the second burst.

18. The method of claim 15 further comprising:
determining that a k-th LP-SS in the second burst is quasi-co-located (QCLed) with a k-th transmitted SS/PBCH block in the first burst.

19. The method of claim 15 further comprising:
determining an on-off-key (OOK) waveform for the LP-SS;
identifying, based on the SIB, a number M of OOK symbols in an orthogonal frequency-division multiplexing (OFDM) symbol;
determining a number N_{LP-SS}^{OOK} of OOK symbols for the LP-SS;
determining a number N_{LP-SS}^{OFDM} of OFDM symbols for the LP-SS;
determining a binary sequence for generating the LP-SS; and
determining, based on the binary sequence, the N_{LP-SS}^{OOK} OOK symbols with the OOK waveform.

20. The method of claim 19, wherein:
$${N}_{LP - SS}^{OFDM} = \frac{{N}_{LP - SS}^{OOK}}{M} ,$$
N_{LP-SS}^{OFDM} is a same value for all carrier spacings of the LP-SS,
an OOK symbol is an ON symbol when a corresponding bit in the binary sequence is 1, and
the OOK symbol is an OFF symbol when the corresponding bit in the binary sequence is 0.
